(19) United States
(12) Patent Application Publication
(10) Pub. No.: US 2017/0171335 A1
(43) Pub. Date: Jun. 15, 2017

(54) ADVERTISING PUSH METHODS, DEVICES, VIDEO SERVERS AND TERMINAL EQUIPMENT

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Weibo AO, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/243,568

(22) Filed: Aug. 22, 2016

Related U.S. Application Data
(63) Continuation of application No. PCT/CN2016/089554, filed on Jul. 10, 2016.

(30) Foreign Application Priority Data
Dec. 14, 2015 (CN) 201510927631.2

(51) Int. Cl. H04L 29/08; G06Q 30/02

(52) U.S. Cl. CPC H04L 67/26; H04L 67/327; H04L 67/34; H04L 67/02; G06Q 30/0277

(57) ABSTRACT

Embodiments of the present invention provide an advertisement push method, a server, and a terminal. The advertisement push method includes: acquiring a plurality of advertisement tags corresponding to video identifiers of a live video from an advertisement server; detecting whether content of the live video satisfies a preset push trigger condition, and acquiring an advertisement tag corresponding to the push trigger condition that the content of the live video satisfies from the plurality of advertisement tags; sending, to a terminal device, a push message carrying the advertisement tag corresponding to the push trigger condition that the content of the live video satisfies. According to embodiments of the present invention, the advertisement push method, the server, and the terminal can provide an advertisement tag related to the live video content to the terminal device, thereby enhancing effectiveness of advertisement push.

### CROSS-REFERENCE TO RELATED APPLICATIONS

The present disclosure is a continuation of PCT application No. PCT/CN2016/089554 submitted on Jul. 10, 2016. This application is based upon and claims priority to Chinese Patent Application No. 201510927631.2, filed before Chinese Patent Office on Dec. 14, 2015 and entitled “ADVERTISEMENT PUSH METHOD AND APPARATUS, VIDEO SERVER, AND TERMINAL DEVICE”, the entire contents of which are incorporated herein by reference.

### TECHNICAL FIELD

The present patent application relates to the field of Internet technologies, and more particularly, to an advertisement push method and a server.

### BACKGROUND

With the development of Internet and mobile Internet technologies, more users use mobile terminals or computers to watch live videos. When a live video is played, a user is often interested in sound, figures, events, or objects appearing in the video, and wishes to view information related to the content of interest in the live video.

In the related arts, advertisements are generally played for a period of time before the live video is played, or advertisements are inserted at suitable time during the process of playing the live video. For example, when live sports events are played on a player of the terminal device, an advertisement lasting for 50 s will be played first, or the advertisement will be inserted in the live program, for example, during half-time break of a football match. However, generally, there is no direct relationship between the played advertisement and the live video.

### SUMMARY

This disclosure provides an advertisement push method and, a server, to provide an advertisement related to content of a live video to the terminal device, thereby enhancing effectiveness of advertisement push.

According to a first aspect of the embodiments of the present invention, an advertisement push method is provided, including: acquiring, from an advertisement server, a plurality of advertisement tags corresponding to video identifiers of a live video; detecting whether live video content satisfies a preset push trigger condition, and acquiring, from the plurality of advertisement tags, an advertisement tag corresponding to the push trigger condition that live video content satisfies; sending, to a terminal device, a push message carrying the advertisement tag corresponding to the push trigger condition that live video content satisfies.

According to a second aspect of the embodiments of the present invention, an advertisement push method is provided, including: receiving a push message that is sent by a video server and carries an advertisement tag corresponding to a push trigger condition that live video content satisfies; sending an advertisement request message to an advertisement server according to the push message, wherein the advertisement request message includes the advertisement tag; and receiving advertisement data that is sent by the advertisement server according to the advertisement tag.

According to a third aspect, an embodiment of this disclosure further provides a server, including: at least one processor; and a memory communicably connected with the at least one processor for storing instructions executable by the at least one processor, where execution of the instructions by the at least one processor causes the at least one processor to: acquire a plurality of advertisement tags corresponding to video identifiers of a live video from an advertisement server; detect whether content of the live video satisfies a preset push trigger condition, and acquire, from the plurality of advertisement tags, an advertisement tag corresponding to the push trigger condition that the content of the live video satisfies; and send, to a terminal device, a push message carrying the advertisement tag corresponding to the push trigger condition that the live video satisfies.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating an advertisement push method provided in the embodiment of the present disclosure;

FIG. 2 is a flowchart illustrating an advertisement push method provided in the embodiment of the present disclosure;

FIG. 3 is a logical block diagram illustrating an advertisement push apparatus provided in the embodiment of the present disclosure;

FIG. 4 is a logical block diagram illustrating an advertisement push apparatus provided in the embodiment of the present disclosure;

FIG. 5 is a schematic structural diagram of hardware of a server for executing an advertisement push method provided in the embodiment of the present disclosure; and

FIG. 6 is a schematic structural diagram of hardware of a terminal for executing an advertisement push method provided in the embodiment of the present disclosure.

### DETAILED DESCRIPTION

A basic concept of embodiments of the present invention is to provide a technical solution for advertisement push. A video server acquires a plurality of advertisement tags corresponding to video identifiers of a live video, further detects whether content of the live video satisfies a preset push trigger condition, and according to the push trigger condition that the content of the live video satisfies, sends a push message of an advertisement tag corresponding to the satisfied push trigger condition to a terminal device. The terminal device sends an advertisement request message to an advertisement server according to the push message, receives advertisement data that is sent by the advertisement server according to the advertisement tag corresponding to the push trigger condition that the content of the live video satisfies, and thus obtains advertisement data related to the content of the live video, thereby enhancing effectiveness of advertisement push and improving user experience.

An advertisement push method and apparatus, a server, and an apparatus according to exemplary embodiments of the present invention are described in detail hereinafter with reference to the accompanying drawings.

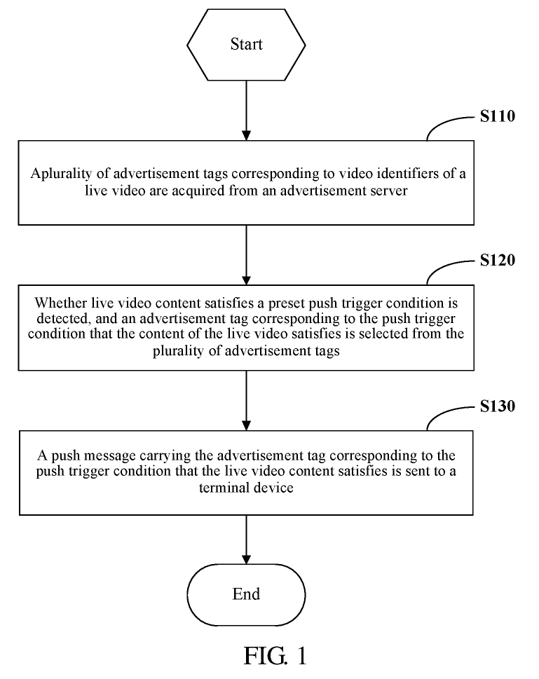

FIG. 1 is a flowchart illustrating an advertisement push method according to an embodiment of the present invention. The method may be performed, for example, on a video server.

Refer to FIG. 1, in step S110, a plurality of advertisement tags corresponding to video identifiers of a live video are acquired from an advertisement server.

The video identifiers herein may be used for identifying different videos, which are also known as video IDs. For example, the live video is a football match between Manchester United and Barca, and the video ID is 300133. Two advertisement tags corresponding to the video ID 300133, that is, an advertisement tagA=1 and an advertisement tagB=2, are acquired from the advertisement server. In practical application, the specific value of the tagA is corresponding to an advertisement resource with a corresponding service relation in the advertisement server.

In step S120, whether live video content satisfies a preset push trigger condition is detected, and an advertisement tag corresponding to the push trigger condition that the content of the live video satisfies is selected from the plurality of advertisement tags.

Still using the live video of the above football match as an example, the preset push trigger condition may include one or more conditions, for example, Manchester United scores or Barca scores.

To obtain the advertisement tag corresponding to the preset push trigger condition, prior to step S120, the method may further include: establish and store a corresponding relationship between the preset push trigger condition and the plurality of advertisement tags. For example, the advertisement tagA corresponds to the preset push trigger condition of “Manchester United scores”. For another example, the advertisement tagB corresponds to the preset push trigger condition of “Barca scores”. Further, whether the content of the live video of the football match satisfies the condition of “Manchester United scores” or satisfies the condition of “Barca scores” can be detected. When the condition of “Manchester United scores” is satisfied, the advertisement tagA corresponding to the push trigger condition of “Manchester United scores” is obtained.

In step S130, a push message carrying the advertisement tag corresponding to the push trigger condition that the live video content satisfies is sent to a terminal device.

In a specific implementation manner, assume that the content of the live video is that Manchester United scores, then the content of the live video satisfies the push trigger condition of “Manchester United scores”, and thus a push message is sent to the terminal device, wherein the push message carries the advertisement tagA=1. In practical application, the push message further may carry the video ID 300133.

According to one embodiment of the present invention, prior to the sending, to a terminal device, a push message carrying the advertisement tag corresponding to the push trigger condition that the live video content satisfies in step S130, the advertisement push method further includes: establishing an HTTP persistent connection with the terminal device, and send, to the terminal device, the push message carrying the advertisement tag corresponding to the trigger condition that the live video content satisfies over the HTTP persistent connection.

According to the embodiment of the present invention, in the advertisement push method, a plurality of advertisement tags corresponding to video identifiers of a live video are acquired from the advertisement server, and whether the content of the live video satisfies the preset push trigger condition is further detected. Based on the push trigger condition that the content of the live video satisfies, the push message of the advertisement tag corresponding to the satisfied push trigger condition is sent to a terminal device, thereby enhancing effectiveness of advertisement push and improving user experience.

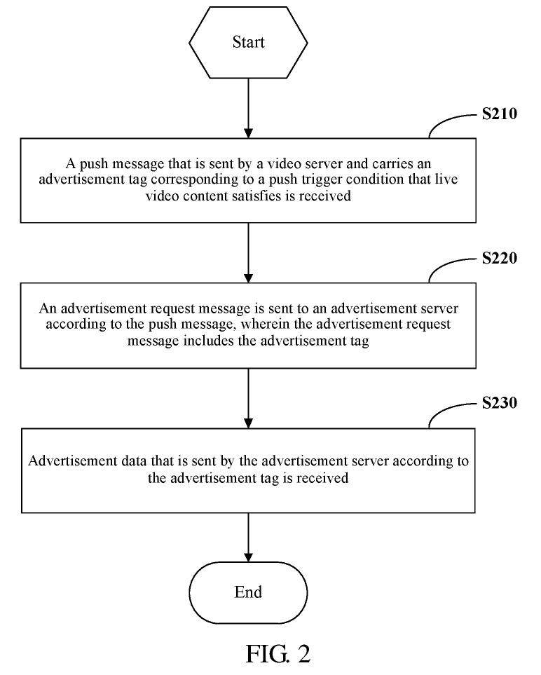

FIG. 2 is a flowchart illustrating an advertisement push method according to the embodiment of the present invention. The method may be performed on a terminal device. The terminal device may include, but not limited to, a PC, a smart phone, a tablet computer or the like.

Refer to FIG. 2, in step S210, a push message that is sent by a video server and carries an advertisement tag corresponding to a push trigger condition that live video content satisfies is received.

In step S220, an advertisement request message is sent to an advertisement server according to the push message, wherein the advertisement request message includes the advertisement tag.

In step S230, advertisement data that is sent by the advertisement server according to the advertisement tag is received.

In a specific implementation manner, the live video of the above football match is still used as an example. After the terminal device receives the push message, when playing the video, the terminal device sends the advertisement request message to the advertisement server immediately, wherein the advertisement request message carries the advertisement tag, such as an advertisement tagA=1, and the advertisement server may select the advertisement data corresponding to the advertisement tag and send the advertisement data to the terminal device. For example, an advertisement of a sponsor of Manchester United is sent to the terminal device, such that the terminal device plays the advertisement. Therefore, a matching degree between the content of the played advertisement and the user requirement is relatively high.

According to embodiments of the present invention, in the advertisement push method, the push message that is sent by the video server and carries the advertisement tag corresponding to the push trigger condition that the content of the live video satisfies is received, and the advertisement request message is sent to the advertisement server according to the push message, to receive the advertisement data that is sent by the advertisement server according to the advertisement tag, and thus obtain the advertisement data related to the content of the live video, thereby enhancing effectiveness of advertisement push and improving user experience.

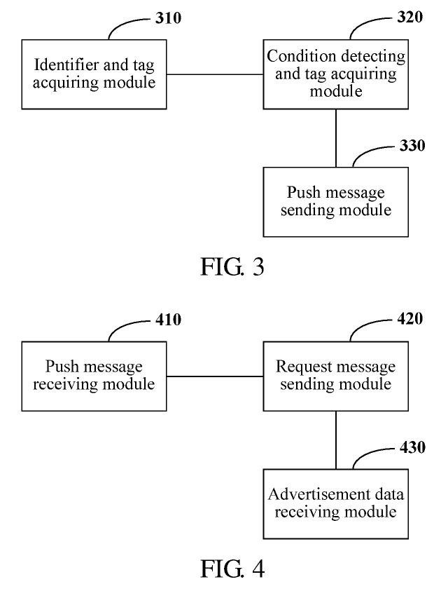

Based on the same inventive concept, FIG. 3 is a logical block diagram illustrating an advertisement push apparatus according to the embodiment of the present invention. The advertisement push apparatus may be used for performing the steps in the embodiment as illustrated in FIG. 1.

Referring to FIG. 3, the advertisement push apparatus includes: an identifier and tag acquiring module 310, a condition detecting and tag acquiring module 320, and a push message sending module 330. The identifier and tag acquiring module 310, the condition detection and tag acquiring module 320, and the push message sending module 330 are connected in sequence.

The identifier and tag acquiring module 310 is configured to acquire a plurality of advertisement tags corresponding to video identifiers of a live video from an advertisement server.

The trigger condition detection module 320 is configured to detect whether live video content satisfies a preset push trigger condition, and select an advertisement tag corresponding to the push trigger condition that the live video content satisfies from the plurality of advertisement tags.

The push message sending module 330 is configured to send, to a terminal device, a push message carrying the advertisement tag corresponding to the push trigger condition that the live video content satisfies.

According to the embodiments of the present invention, in the advertisement push apparatus, a plurality of advertisement tags corresponding to video identifiers of the live video are acquired from the advertisement server, and whether the content of the live video satisfies the preset push trigger condition is further detected. Based on the push trigger condition that the content of the live video satisfies, the push message of the advertisement tag corresponding to the satisfied push trigger condition is sent to the terminal device, thereby enhancing effectiveness of advertisement push and improving user experience.

To mitigate network congestion, the push message sending module 330 is further configured to establish an HTTP persistent connection with the terminal device, and send, to the terminal device, the push message carrying the advertisement tag corresponding to the push trigger condition that the content of the live video satisfies over the HTTP persistent connection.

In an embodiment, the advertisement push apparatus further includes: a corresponding relationship establishing and storing module (not illustrated), configured to establish and store a corresponding relationship between the preset push trigger condition and the plurality of advertisement tags. In this way, when any preset push trigger condition is satisfied, the apparatus searches the corresponding relationship, and sends the advertisement tag corresponding to the satisfied push trigger condition to the terminal device.

Based on the same inventive concept, FIG. 4 is a logical block diagram illustrating an advertisement push apparatus according to the embodiment of the present invention. The advertisement push apparatus may be used for performing the steps in the embodiment as illustrated in FIG. 2.

Referring to FIG. 4, the advertisement push apparatus includes: a push message receiving module 410, a request message sending module 420, and an advertisement data receiving module 430. The push message receiving module 410, the request message sending module 420, and the advertisement data receiving module 430 are connected in sequence.

The push message receiving module 410 is configured to receive a push message that is sent by a video server and carries an advertisement tag corresponding to a push trigger condition that live video content satisfies.

The request message sending module 420 is configured to send an advertisement request message to an advertisement server according to the push message, wherein the advertisement request message includes the advertisement tag.

The advertisement data receiving module 430 is configured to receive advertisement data that is sent by the advertisement server according to the advertisement tag.

According to the embodiments of the present invention, in the advertisement push apparatus, the push message that is sent by the video server and carries the advertisement tag corresponding to the push trigger condition that the content of the live video satisfies is received, and the advertisement request message is sent to the advertisement server according to the push message, to receive the advertisement data that is sent by the advertisement server according to the advertisement tag, and thus obtain the advertisement data related to the content of the live video, thereby enhancing effectiveness of advertisement push and improving user experience.

An embodiment of this disclosure provides a non-volatile computer storage medium, which stores computer executable instructions, where the computer executable instructions can execute the advertisement push method in the foregoing embodiment.

An embodiment of this disclosure provides a non-volatile computer storage medium, which stores computer executable instructions, where the computer executable instructions can execute the advertisement push method in the foregoing embodiment.

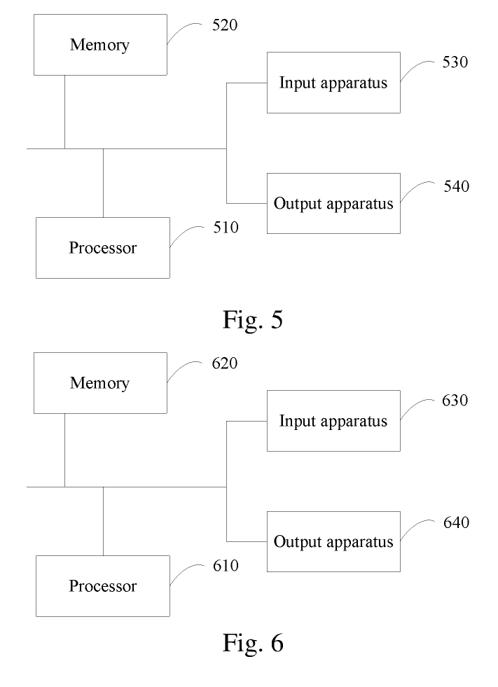

According to a server of the advertisement push method provided in the embodiment of this disclosure, a schematic structural diagram of hardware is as shown in FIG. 5. The server includes: one or more processors 510 and a memory 520, where only one processor 510 is used as an example in FIG. 5.

A server for executing the advertisement push method may further include: an input apparatus 530 and an output apparatus 540.

The processor 510, the memory 520, the input apparatus 530, and the output apparatus 540 can be connected by means of a bus or in other manners. A connection by means of a bus is used as an example in FIG. 5.

Storage medium 520 is a non-transitory computer-readable medium for storing a non-transitory software program, a non-transitory computer-readable program and module, for example the program instructions/module for performing an above described method (e.g. Identifier and tag acquiring module 310, Condition detection and tag acquiring module 320 and Push message sending module 330 shown in FIG. 3). The processor 510 can operate the various functions and data processing of a server to perform advertisement push method described in the above embodiments by executing non-transitory software programs, instructions and modules stored in the storage medium 520.

The storage medium 520 can include a program storage area and a data storage area. Among them, the program storage area may store operation system, application programs of at least one function; the data storage area may store generated data during operation of the electronic apparatus for performing the advertisement push method described in the above embodiments. In addition, the storage medium 520 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium 520 may include a storage medium that is remote to the processor 510. The remote storage medium may be connected to the electronic apparatus for performing any of the above methods by a network. The examples of such as network include but not limited to Internet, enterprise intranet, local area network, mobile telecommunication network and a combination thereof.

The input apparatus 530 can receive input number or byte information, and can generate input key information relating to user setting and functional control of the electronic apparatus for performing the method described in the above embodiments. The output apparatus 540 may include a display device such as a display screen.

The one or more modules stored in the storage medium 520 that, when executed by the one or more processors 510, can perform any of the above described methods.

According to a terminal of the advertisement push method provided in the embodiment of this disclosure, a schematic structural diagram of hardware is as shown in FIG. 6. The terminal includes: one or more processors 610 and a memory 620, where only one processor 610 is used as an example in FIG. 6.

A device for executing the advertisement push method may further include: an input apparatus 630 and an output apparatus 640.

The processor 610, the memory 620, the input apparatus 630, and the output apparatus 640 can be connected by means of a bus or in other manners. A connection by means of a bus is used as an example in FIG. 6.

Storage medium 620 is a non-transitory computer-readable medium for storing a non-transitory software program, a non-transitory computer-readable program and module, for example the program instructions/module for performing an above described method (e.g. push message module 410, request message sending module 420 and advertisement data receiving module 430 shown in FIG. 4). The processor 610 can operate the various functions and data processing of a server to perform the advertisement push method described in the above embodiments by executing non-transitory software programs, instructions and modules stored in the storage medium 620.

The storage medium 620 can include a program storage area and a data storage area. Among them, the program storage area may store operation system, application programs of at least one function; the data storage area may store generated data during operation of the electronic apparatus for performing the advertisement push method described in the above embodiments. In addition, the storage medium 620 may include a high speed random access memory, and a non-transitory storage medium, for example a magnetic storage device (e.g., hard disk, floppy disk, and magnetic strip), a flash memory device (e.g., card, stick, key drive) or other non-transitory solid state storage device. In some embodiments, the storage medium 620 may include a storage medium that is remote to the processor 610. The remote storage medium may be connected to the electronic apparatus for performing any of the above methods by a network. The examples of such as network include but not limited to Internet, enterprise intranet, local area network, mobile telecommunication network and a combination thereof.

The input apparatus 630 can receive input number or byte information, and can generate input key information relating to user setting and functional control of the electronic apparatus for performing the advertisement push method described in the above embodiments. The output apparatus 640 may include a display device such as a display screen.

The one or more modules stored in the storage medium 620 that, when executed by the one or more processors 610, can perform any of the above described methods.

The above products can perform any of the above described methods, and have corresponding functional modules and effects. Details that are not disclosed in this embodiment can be understood by reference to the above method embodiments of the present disclosure.

The above described apparatus embodiments are for illustration purpose only, in which modules/units that are described above as separate elements may be physically separate or not separate and modules/units that are described above as display elements may be or may not be a physical unit, i.e. in a same location or in various distributed network units. The skilled person in this field can understand that it is possible to select some or all of the units or modules to achieve the purpose of the embodiment.

According to the above description, the skilled person in this field can understand that various embodiments can be implemented by software over a general hardware platform or by hardware. Accordingly, the above technical solution or what is contributed to the prior art may be implemented in the form of software product. The computer software product may be stored in a computer-readable storage medium, for example random access memory (RAM), read only memory (ROM), compact disk (CD), digital versatile disk (DVD) etc. which includes instructions for causing a computing device (e.g. a personal computer, a server or a network device etc.) to perform a method of some or all parts of any one of the above described embodiments.

Finally, it should be noted that the previous embodiments are provided to enable any person skilled in the art to practice the various embodiments of the present disclosure described herein but not to limit these aspects. Though the present disclosure is described by reference to the previous embodiments, various modifications and equivalent features will be readily apparent to those skilled in the art without departing from the spirit and scope of the present disclosure, and the generic principles defined herein may be applied to other aspects or with equivalent features. Thus, the claims are not intended to be limited to the aspects and features shown herein, but are to be accorded the full scope consistent with the language of the claims.

What is claimed is:

1. An advertisement push method, comprising:
acquiring, from an advertisement server, a plurality of advertisement tags corresponding to video identifiers of a live video;
detecting whether live video content satisfies a preset push trigger condition, and acquiring, from the plurality of advertisement tags, an advertisement tag corresponding to the push trigger condition that the live video content satisfies;
sending, to a terminal device, a push message carrying the advertisement tag corresponding to push trigger condition that the live video content satisfies.

2. The method according to claim 1, before the sending, to a terminal device, a push message carrying the advertisement tag corresponding to the push trigger condition that the live video content satisfies, further comprising:
establishing an HTTP persistent connection with the terminal device; and
sending, to the terminal device, the push message carrying the advertisement tag corresponding to the push trigger condition that the live video content satisfies over the HTTP persistent connection.

3. The method according to claim 1, wherein, before the detecting whether live video content satisfies the preset push trigger condition, the method further comprises:
establishing and storing a corresponding relationship between the preset push trigger condition and the plurality of advertisement tags.

4. An advertisement push method, comprising:
receiving a push message that is sent by a video server and carries an advertisement tag corresponding to a push trigger condition that live video content satisfies;
sending an advertisement request message to an advertisement server according to the push message, wherein the advertisement request message comprises the advertisement tag; and
receiving advertisement data that is sent by the advertisement server according to the advertisement tag.

5. A server, comprising:
at least one processor; and
a memory communicably connected with the at least one processor, wherein the memory stores instructions executable by the at least one processor, and the instructions are executed by the at least one processor, to cause the at least one processor to:
acquire, from an advertisement server, multiple advertisement tags corresponding to video identifiers of a live video;
detect whether live video content satisfies a preset push trigger condition, and acquire, from the multiple advertisement tags, an advertisement tag corresponding to the push trigger condition that the live video content satisfies;
send, to a terminal device, a push message carrying the advertisement tag corresponding to push trigger condition that the live video content satisfies.

6. The server according to claim 5, wherein the at least one process further can:
establish an HTTP persistent connection with the terminal device; and
send, to the terminal device, the push message carrying the advertisement tag corresponding to the push trigger condition that the live video content satisfies by means of the HTTP persistent connection.

7. The server according to claim 5, wherein the at least one process is further caused to:
establish and store correspondence between the preset push trigger condition and the multiple advertisement tags.
